(19) United States
(12) Patent Application Publication
(10) Pub. No.: US 2011/0283701 A1
(43) Pub. Date: Nov. 24, 2011

(54) Self Powered Cooling

(76) Inventor: Shahriar Eftekharzadeh, Torrance, CA (US)

(21) Appl. No.: 13/204,681

(22) Filed: Aug. 7, 2011

(51) Int. Cl. G21D 5/00

(52) U.S. Cl. 60/644.1

(57) ABSTRACT

An apparatus that harnesses the thermal energy of spent fuel rods in nuclear power plants to power the cooling system of the nuclear power plant particularly the cooling for the spent fuel rod storage ponds and the main reactors. The apparatus is comprised of a heat exchanger unit that accumulates the thermal energy of the spent fuel rods, a heat conveyance system that conveys the thermal energy of the spent fuel rods, and a heat engine that receives its thermal energy input from the spent fuel rods and produces mechanical power that runs an electrical generator which powers the cooling system of the nuclear power plant, particularly the controls and pumps that cool the spent fuel rod storage ponds and the main reactors. The apparatus provides a redundant power source and makes the cooling system of nuclear power plants independent of externally supplied electrical power and thereby resolves a key redundancy and safety concern with nuclear power generation. The apparatus also has application to other industries.

### FIELD OF THE INVENTION

The present invention relates to industrial cooling systems, and more specifically to improvements thereto for powering such systems with a redundant power source that is not subject to outage. Specifically, the present invention harnesses the thermal energy of spent fuel rods in nuclear power plants to power the spent fuel rod storage ponds and reactors. The present invention may also be used in other industries to harness the thermal energy of process waste heat to power the process cooling system.

### BACKGROUND OF THE INVENTION

Cooling is the conveyance and disposal of the waste heat generated in any process where thermal energy is converted to useful work. It is a fundamental requirement without which the process cannot be sustained. Most processes used in everyday modern life, such as in power generation, manufacturing, petrochemicals, transportation, processing, construction, etc., rely on active cooling systems that require power to operate. Power is required for the operation and control of electrical motors in pumps, fans, valves, gates, etc., to convey the coolant from the low temperature source through the heat source within the process to the heat sink. Additional power is required in re-circulating cooling systems to operate the cooling towers or refrigeration units that provide the terminal cooling for the system.

Failures or disruptions in the operation of cooling systems cannot be tolerated as it results in the stoppage of the main process with adverse and undesirable consequences. Therefore, cooling systems incorporate redundancies for key components, particularly for power, to maintain continued operation in the event of component failure or power outage. Power redundancy is usually provided in the form of standby generators, batteries, or both. The aim is to make the cooling system as fail-safe as possible.

Nuclear power generation is unique in that waste heat generation does not cease once the plant is shut down. Heat generation continues owing to the natural decay of the fission products in the fuel rods. This is true even when the fuel rods are considered spent and transferred from the reactors to the spent fuel rod storage ponds where they are kept for several years. The fuel rods require continuous and uninterrupted cooling both in the reactors and the spent fuel storage ponds at all times, even when the plant is shut down. In the absence of adequate cooling, the fuel rods can heat up to extremely high temperatures and cause meltdown with catastrophic consequences.

Therefore, redundant power for the cooling system of nuclear power plants is critically important because failure of the cooling system can have catastrophic consequences. Normally, the nuclear power plant cooling system is connected to both the power plant and the electrical grid for primary power supply, while backup generators provide emergency power in the event of power outage in the grid. In addition, batteries are provided to backup the generators in case of temporary disruption in power supply by the generators.

However, the current power redundancy arrangement for nuclear power plants has proven to be fatally inadequate. This is a fact that was tragically demonstrated by the Fukushima Daiichi nuclear power plant cooling system failure in Japan following the 9.0 magnitude Tohoku earthquake and tsunami on 11 Mar. 2011. The earthquake prompted the automatic shut down of the nuclear power plant, which cut off the main power supply to the cooling system. This in turn prompted the startup of the emergency generators to run the cooling system water pumps and the control electronics. However, the Tsunami that followed caused the entire plant to flood, including the backup emergency generators and electrical switchgear. Also, the connection to the electrical grid was broken as the Tsunami destroyed the power lines. The backup batteries were only adequate for a few hours of cooling system operation. All power for cooling was lost and reactors started to overheat and meltdown owing to the natural decay of the fission products in the fuel rods. The water in the spent fuel storage pond started to overhead and to generate hydrogen which subsequently exploded with catastrophic consequences. The accident prompted a complete revision of the integrity and safety of nuclear power worldwide. The failure has been attributed to the inability to furnish a truly redundant and fail-safe power supply source for the cooling system.

Therefore, there remains an urgent need to furnish a truly a truly independent and redundant power source for cooling system in nuclear power generation plants capable of continued operation to provide adequate cooling once all external power sources are disrupted. Such as system would also have application in other industries where continuous and uninterrupted cooling is needed to assure safety and prevent material damage or degradation.

### SUMMARY OF THE INVENTION

The present invention provides an answer to the above stated need by using the thermal energy of the spent fuel rods as the main source of power for the operation of the nuclear power plant cooling system, making it an internally powered cooling system that does not require any external source of electrical power for its intended operation, and therefore cannot be disrupted by external power outages. The cooling system operation will continue without interruption for as long as there is adequate thermal energy in the spent fuel rods, which is in the order of several years after removal from the reactors and transfer to the spent fuel rod storage ponds. The invention may also be used in other industries by using the thermal energy of the process waste heat as the main source of power for the operation of the plant cooling system. For such applications the cooling system is designed to continue operation until the reduction in the waste heat due to process shut down and continued cooling reaches a level where active cooling is no longer required to ensure safety or to prevent material damage. Therefore, the present invention makes the cooling systems in both nuclear power generation and in other industries immune from external power outage.

The preferred embodiment of the invention uses a heat engine, such as the Sterling Engine, Steam Engine, Steam Turbine, or similar to convert the thermal energy of the fuel rods or the process waste heat to mechanical work that could either be used to generate electricity to operate the cooling system, and/or to directly power the cooling system pumps. The heat engine receives its thermal energy input from the spent fuel rods or process waste heat source(s) via appropriately designed heat exchange and heat transfer/conveyance systems. The invention may either be configured as a self contained packaged units installed in one location, or as separate components installed at various locations within the plant.

The difference between the present invention and previous inventions that also work by recovery and conversion of process thermal energy and waste heat is the object of the present invention, which is to use the recovered thermal energy for powering the cooling system of the process itself i.e. to realize power redundancy for the process cooling system. This is fundamentally different from the recovery and conversion of process waste heat to improve process efficiency, for which there is ample precedence. The fact that the present invention uses the process waste heat for thermal energy input means that it also improves process efficiency, but that is not an object of this invention.

It is an object of the invention to provide a redundant power source for the cooling system of nuclear power plants by apparatus described so as to make the cooling system independent of externally supplied electrical power.

It is an object of the invention to provide a redundant power source for the cooling system of other industries in power generation, manufacturing, petrochemicals, transportation, processing, construction, etc., by apparatus described as to make the cooling system of those industries independent of externally supplied electrical power.

### BRIEF DESCRIPTION OF THE DRAWINGS

FIG. 1 is a schematic diagram of one embodiment of the invention in nuclear power generation application using conduction for heat transfer between the spent fuel rods and the heat engine.

FIG. 2 is a schematic diagram of one embodiment of the invention in nuclear power generation application using a liquid medium in piping for heat transfer between the spent fuel rods and the heat engine.

FIG. 3 is a schematic diagram of one embodiment of the invention in nuclear power generation application using steam for converting the thermal energy of the spent fuel rods to electricity.

FIG. 4 is a schematic diagram of one embodiment of the invention in nuclear power generation application using submersible pumps for cooling the spent fuel pond.

FIG. 5 is a schematic diagram of one embodiment of the invention in nuclear power generation application using submersible electrical generation units inside the spent fuel pond.

FIG. 6 is a schematic diagram of one embodiment of the invention in other industries application using the process waste heat to generate electricity for the cooling system.

### DETAILED DESCRIPTION

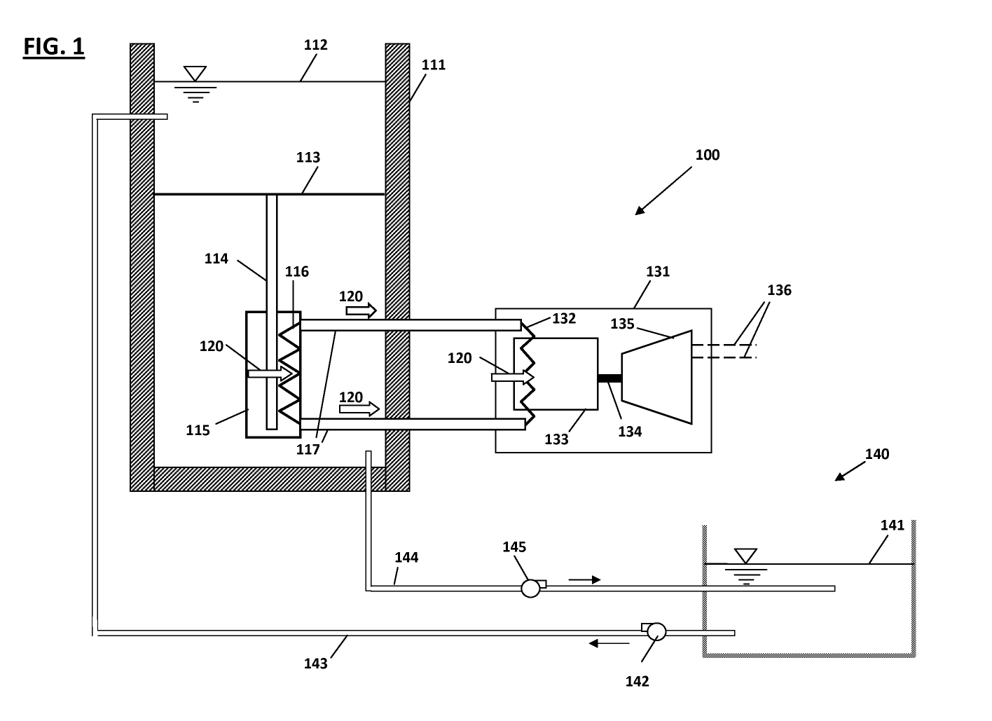

Referring first to FIG. 1, there is shown an apparatus 100 that harnesses the thermal energy 120 of the spent fuel rod 114 to power the nuclear power plant cooling system 140, according to one embodiment of the invention. Heat exchanger unit 115 is accumulates the thermal energy 120 of the spent fuel rods 114 held by support 113 inside the spent fuel rod storage pond 111 by controlled shielding of the spent fuel rods 114 from the surrounding cooling water 112 so as to achieve a pre-determined elevated temperature inside the heat exchanger 115. Internal element 116 transfers the thermal energy 120 to heat conductors 117 which convey it to the electrical power generation unit 131 by heat conduction. The latter consists of a heat engine such as a Sterling Engine 133, which receives the thermal energy 120 via element 132 and converts it to mechanical energy that drives the electrical generator 135 via transmission system 134. Electricity generated by unit 131 is transmitted via electrical cables 136 to power all controls and pumps associated with the nuclear power plant cooling system 140, which is shown as a once-through system in this embodiment. Pump 142 supplies cold water from open water body 141 via cold water pipe 143 to spent fuel pond 111, while pump 145 returns the hot water from the spent fuel pond 111 via hot water pipe 144 back to the open water body. Although not shown, the electricity generated could equally be used to power a re-circulating cooling system that uses cooling towers in lieu of the once through system 140 shown. The apparatus 100 is preferably sized in sufficient numbers and equipment capacity to provide adequate electrical power for the cooling system 140 such that there is no need for any externally supplied electrical power for normal operation. Alternatively, the apparatus 100 may be sized to only provide sufficient power for emergency level cooling to prevent excessive overheating of the spent fuel storage ponds during external power outage.

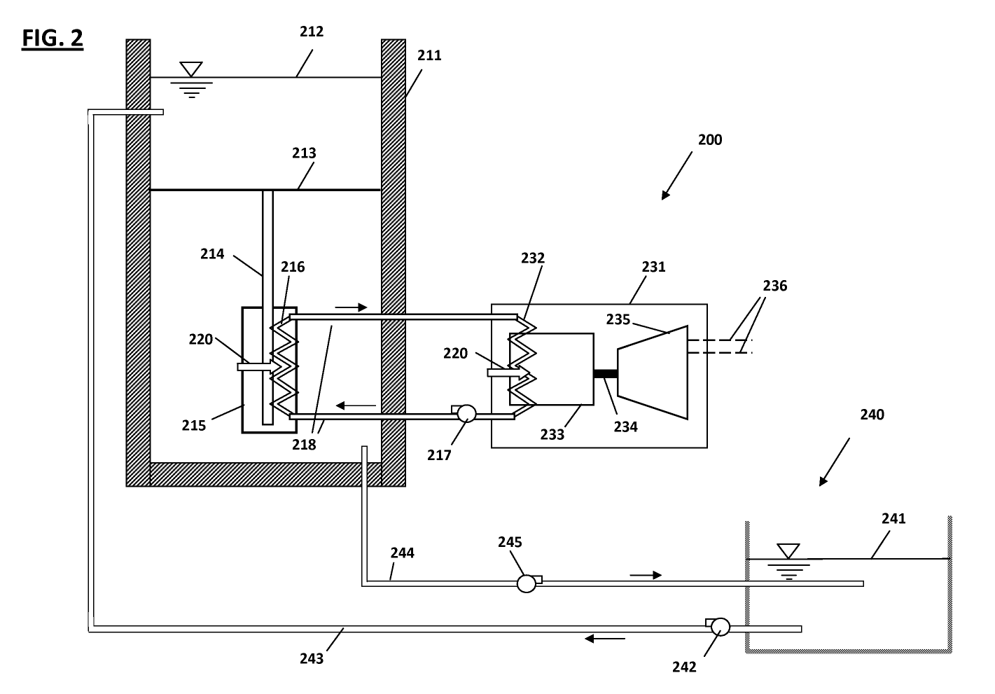

FIG. 2 is another embodiment of the invention showing an apparatus 200 that is almost identical in its principal of operation to apparatus 100 shown in FIG. 1, but uses liquid communication for thermal energy transfer instead of conduction. The heat exchanger unit 215 accumulates the thermal energy 220 of the spent fuel rods 214 held by support 213 inside the spent fuel rod storage pond 211 by controlled shielding of the spent fuel rods 214 from the surrounding cooling water 212 so as to achieve a pre-determined elevated temperature inside the heat exchanger 215. Plate or tube heat exchangers 216 and 232 are connected by conveyance piping 218 and recirculation pump 217 to convey the thermal energy 220 to the electrical power generation unit 231. The latter consists of a heat engine such as a Sterling Engine 233 that converts the thermal energy 220 to mechanical energy that drives the electrical generator 235 via transmission system 234. Electricity generated by unit 231 is transmitted via electrical cables 236 to power all controls and pumps associated with the nuclear power plant cooling system 240, which is shown as a once-through system in this embodiment. Pump 242 supplies cold water from open water body 241 via cold water pipe 243 to spent fuel pond 211, while pump 245 returns the hot water from the spent fuel pond 211 via hot water pipe 244 back to the open water body. Although not shown, the electricity generated could equally be used to power a re-circulating cooling system that uses cooling towers in lieu of the once through system 240 shown. As with apparatus 100 shown in FIG. 1, apparatus 200 is preferably sized in sufficient numbers and equipment capacity to provide adequate electrical power for the normal operation of cooling system 240 without the need for any externally supplied electrical power. Alternatively, apparatus 200 may be sized to only provide sufficient power for emergency level cooling to prevent excessive overheating of the spent fuel storage ponds during external power outage. Given that pump 217 must operate before generator 235 can start operation, pump 217 must be connected to a source such as a battery unit that enables the operation of the pump without the generator 235 being in operation but maintains its charge by connecting to generator 235 via electrical cables 236.

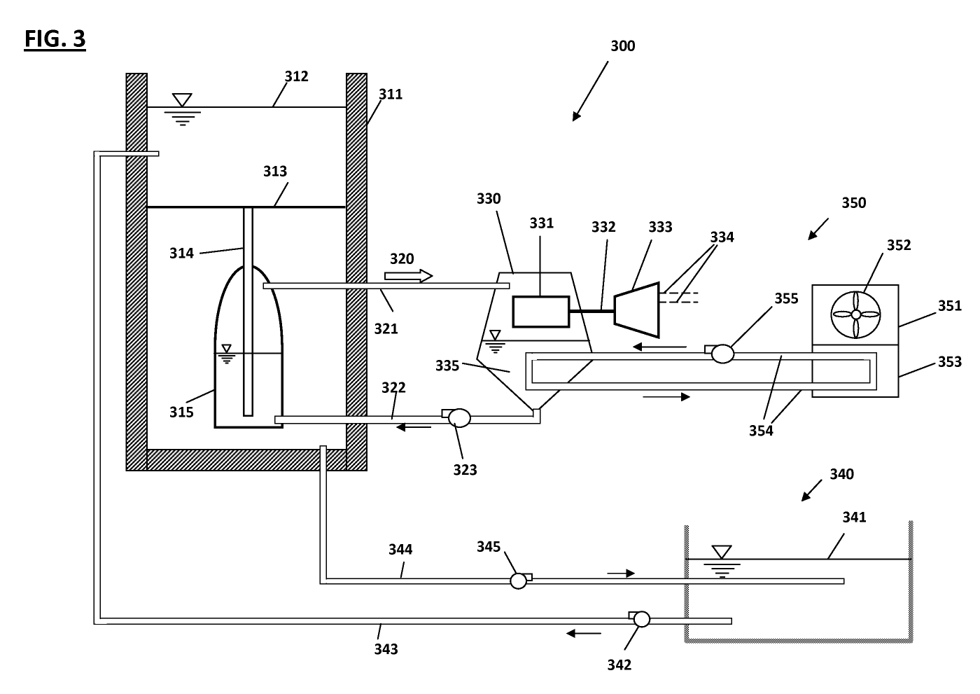

FIG. 3 is another embodiment of the invention showing an apparatus 300 that is similar in its principal of operation to apparatus 100 shown in FIG. 1, but uses steam for conversion of thermal energy to mechanical work. The steam generator unit 315 encapsulates the spent fuel rods 314 held by support 313 inside the spent fuel rod storage pond 311, either in part or in their entirety so as to achieve and maintain a pre-determined temperature and pressure inside the steam generator unit 315. Although not shown, a separate and dedicated facility from the spent fuel rod storage pond may be used for the steam generator 315 in lieu of housing it inside the spent fuel pond. Alternatively, heat transfer arrangements shown in FIGS. 1 and 2 could be used to convey the heat to the steam generator outside the spent fuel pond instead of the steam generator encapsulating the spent fuel rods inside the pond. Piping 321 conveys the steam 320 to condensing steam turbine unit 330. Steam turbine 331 produces mechanical energy to drive the electrical generator 333 via transmission system 332. Condensate 335 is pumped by pump 323 and returned to steam generator 315 via piping 322. Cooling for the condensing steam turbine may be provided by cooling system 350 comprised of cooling tower 351, fans 352, basin 353, piping 354, and recirculating pump 355. Although not shown, a non-condensing steam turbine could also be used in addition to a condensing steam turbine if that achieves better heat conversion efficiency or has other advantages. Also, cooling for the condensing steam turbine may alternatively be provided by the nuclear power plant once through system 340 instead of a separate system 350. Electricity generated by unit 333 is transmitted via electrical cables 334 to power all controls and pumps associated with the nuclear power plant cooling systems 340 and 350, which are shown as once-through and recirculating systems respectively in this embodiment, but may be any combination and type of viable cooling systems. Pump 342 supplies cold water from open water body 341 via cold water pipe 343 to spent fuel pond 311, while pump 345 returns the hot water from the spent fuel pond 311 via hot water pipe 344 back to the open water body. Although not shown, the electricity generated could equally be used to power a re-circulating cooling system that uses cooling towers in lieu of the once through system 340 shown. As with apparatus 100 shown in FIG. 1, apparatus 300 is preferably sized in sufficient numbers and equipment capacity to provide adequate electrical power for the normal operation of cooling systems 340 and 350 without the need for any externally supplied electrical power. Alternatively, apparatus 300 may be sized to only provide sufficient power for emergency level cooling to prevent excessive overheating of the spent fuel storage ponds during external power outage. Given that pumps 323 and 355 must operate before generator 333 can start operation, they must be connected a source such as a battery unit that enables the operation of the these pumps without the generator 333 in operation but maintains its charge by connecting to generator 333 via electrical cables 334.

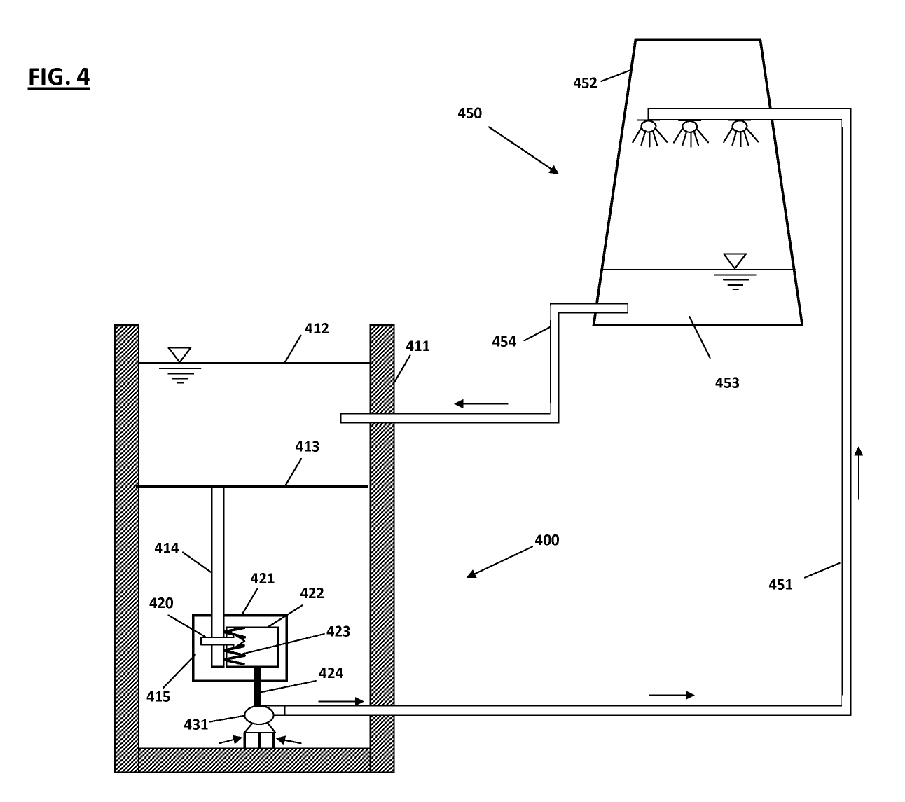

FIG. 4 is another embodiment of the invention showing an apparatus 400 that harnesses the thermal energy of the spent fuel rods to directly power a submersible pump to recirculate the water in the spent fuel rod pond of a nuclear power plant. Heat exchanger unit 415 accumulates the thermal energy 420 of the spent fuel rods 414 held by support 413 inside the spent fuel rod storage pond 411 by controlled shielding of the spent fuel rods 414 from the surrounding cooling water 412 so as to achieve a pre-determined elevated temperature inside the heat exchanger 415. Internal element 423 transfers the thermal energy 420 to heat engine 422, which converts it to mechanical energy that directly drives the submersible pump 431 via transmission 424. Pump 431 pumps the spent fuel rod pond water 412 to cooling system 450, which is comprised of piping 451, natural draft cooling tower 451, basin 453, and gravity return piping 454. The embodiment of the invention shown in FIG. 4 does not require electricity to operate the cooling system pumps, while the use of natural draft cooling tower 452 means that no electricity is required to achieve cooling at the cooling tower. Also, the cold water basin 453 of the cooling tower is located at an elevation above the elevation of the spent fuel rod storage pond water level 412, such that cold water returns to the storage pond by gravity. However, electricity is still required for the cooling system control electronics and may be required for the supply of makeup water to the cooling tower. Although not shown, the electricity required could be provided by incorporating an electrical generator within apparatus 400 to drive off of the transmission system 424, or it could be independently generated by an appropriately sized apparatus shown in FIG. 1, or by other independent means such as solar power.

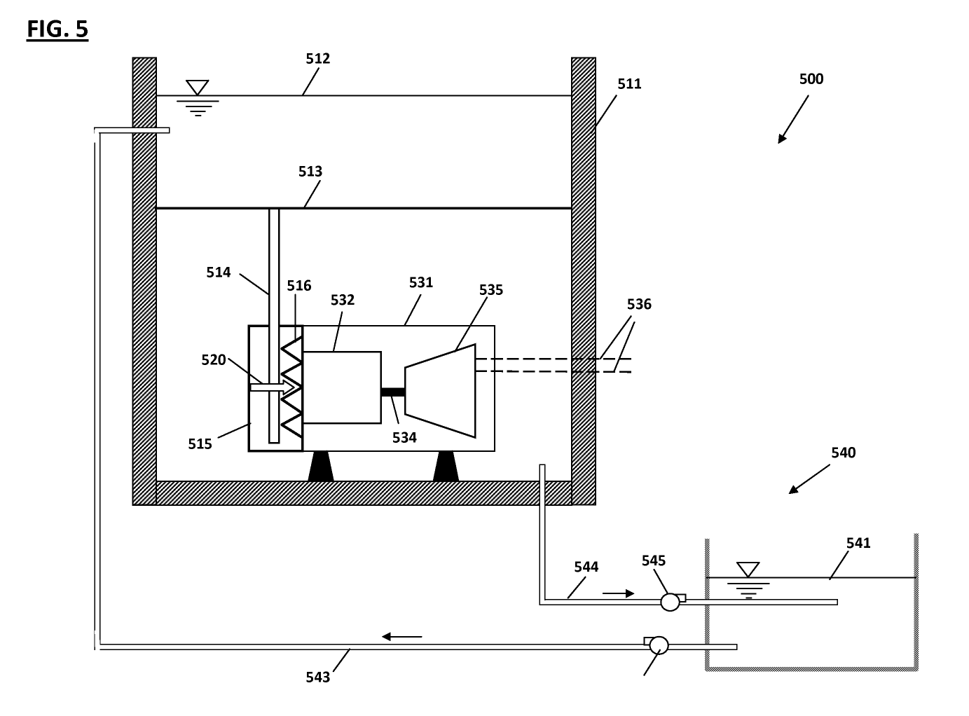

FIG. 5 is another embodiment of the invention showing an apparatus 500 that harnesses the thermal energy of the spent fuel rods to power a submersible electricity generating unit(s) which provides the electricity for the nuclear power plant cooling system. Heat exchanger unit 515 accumulates the thermal energy 520 of the spent fuel rods 514 held by support 513 inside the spent fuel rod storage pond 511 by controlled shielding of the spent fuel rods 514 from the surrounding cooling water 512 so as to achieve a pre-determined elevated temperature inside the heat exchanger 515. Internal element 516 transfers the thermal energy 4520 to heat engine 532 which converts it to mechanical energy that drives the electrical power generation unit 535 via transmission system 534. Electricity generated by unit 531 is transmitted via electrical cables 536 to power all controls and pumps associated with the nuclear power plant cooling system 540, which is shown as a once-through system in this embodiment. Pump 542 supplies cold water from open water body 541 via cold water pipe 543 to spent fuel pond 511, while pump 545 returns the hot water from the spent fuel pond 511 via hot water pipe 544 back to the open water body 541. Although not shown, the electricity generated could equally be used to power a re-circulating cooling system that uses cooling towers in lieu of the once through system 540 shown. The apparatus 500 is preferably sized in sufficient numbers and equipment capacity to provide adequate electrical power for the cooling system 540 such that there is no need for any externally supplied electrical power for normal operation. Alternatively, the apparatus 500 may be sized to only provide sufficient power for emergency level cooling to prevent excessive overheating of the spent fuel storage ponds during external power outage.

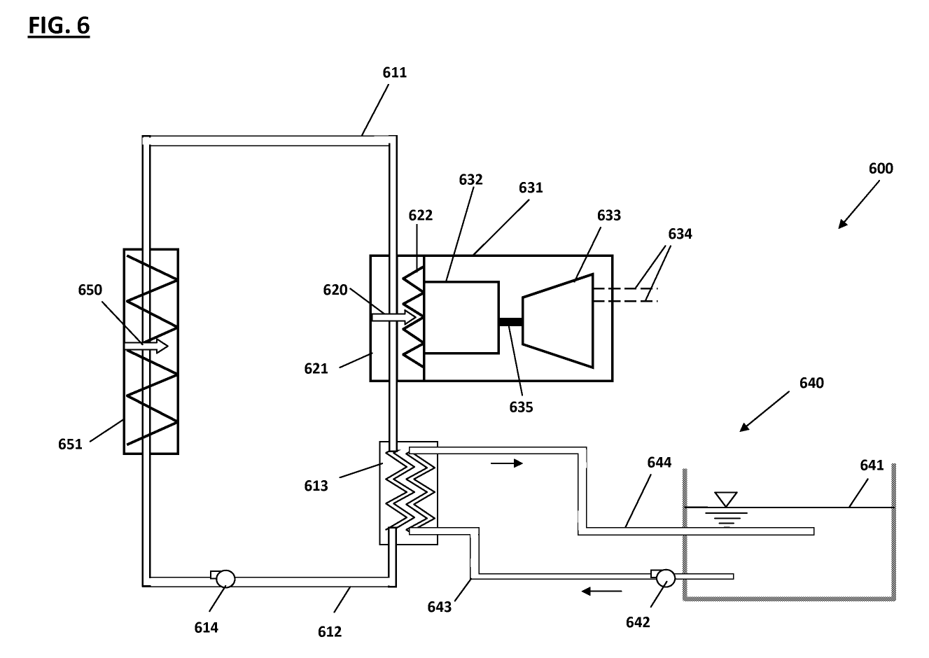

FIG. 6 is another embodiment of the invention showing an apparatus 600 that harnesses the process waste heat 650 in industries such as power generation, manufacturing, petrochemicals, transportation, processing, construction, etc., to generate electricity to power the process cooling system. Cooling pump 614 circulates coolant through process 651 to collect and convey waste heat 650 from within process 651 via high-temperature piping 611, heat exchanger 613, and low temperature piping 612. Part of the waste heat 650 is harnessed upstream of the cooling system heat exchangers 631 at single or multiple locations as necessary by heat exchanger 621. Internal element 622 transfers the harnessed waste heat 620 to heat engine 632, which converts it to mechanical energy that drives the electrical power generation unit 633 via transmission system 635. Electricity generated is transmitted via electrical cables 634 to power all controls and pumps of cooling system 640, which is shown as a once-through system in this embodiment, as well as pump(s) 614 and its controls. Pump 642 pumps cold water from open water body 641 via cold water pipe 643 to heat exchanger 613, and returns the hot water from the heat exchanger 613 via hot water pipe 644 back to the open water body 641. Although not shown, the electricity generated could equally be used to power a re-circulating cooling system that uses cooling towers in lieu of the once through system 640. The apparatus 600 is preferably sized in sufficient numbers and equipment capacity to provide adequate electrical power for the cooling system 640 such that there is no need for any externally supplied electrical power for normal operation. Alternatively, the apparatus 600 may be sized to only provide sufficient power for emergency level cooling to prevent excessive overheating of the spent fuel storage ponds during external power outage. Given that pump 614 must operate before generator 633 can start operation, pump 614 must be connected to a source such as a battery unit that enables the operation of the pump without the generator 634 being in operation but maintains its charge by connecting to generator 634 via electrical cables 634.

The present invention is susceptible to modifications and variations which may be introduced thereto without departing from the inventive concepts and the object of the invention. Mechanisms other than heat conduction, liquid communication, and steam may be used for heat transfer, and other types of heat engines may be employed to convert the waste heat energy to suitable forms that may be used in a variety of configurations to power the cooling system. For example, the waste heat may be directly used to power an adsorption cooling system to furnish part or all of the process cooling needed to accomplish redundancy. Such modifications and variations are within the invention concepts.

Although presented in terms of cooling systems in nuclear power plant generation and in other industries, the present invention is obviously adaptable to other situations where process waste heat may be used to power the cooling system of the process. For example, the waste heat generated at an electronic component may be used to drive a local cooling system for that component, or the exhaust heat from an engine could be used to power a cooling system for the engine and/or the exhaust. The essence of the present invention is the harnessing of the heat generated by or in a given process for the cooling of the process and/or removal of the heat.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1-10. (canceled)

11. An apparatus that harnesses the thermal energy of spent fuel rods of a nuclear power plant to power at least one cooling system of said nuclear power plant, wherein the nuclear power plant has a main reactor, a cooling system serving the main reactor, and a cooling system for cooling a spent fuel rod storage pond, the apparatus comprising:
a spent fuel rod storage pond containing a fluid and spent fuel rods, which spent fuel rods evolve waste heat;
a heat engine disposed to convert thermal energy from the waste heat to mechanical power;
a heat conveyance system that conveys thermal energy of the spent fuel rods to the heat engine; and
a cooling system for cooling the spent fuel rod storage pond, including at least one liquid circulating pump for which power is ultimately derived from the heat engine.

12. The apparatus of claim 11, wherein the heat engine is located externally to the spent fuel rod storage pond.

13. The apparatus of claim 11, wherein the heat engine is located internally within the spent fuel rod storage pond.

14. The apparatus of claim 11, wherein the heat conveyance system conveys thermal energy by conduction.

15. The apparatus of claim 11, wherein the heat conveyance system conveys thermal energy by fluid circulation.

16. The apparatus of claim 11, wherein the heat engine comprises a boiler disposed within the spent fuel rod storage pond.

17. The apparatus of claim 11, wherein mechanical power produced by the heat engine directly drives the liquid circulating pump of the cooling system.

18. The apparatus of claim 17, wherein the liquid circulating pump is disposed within the spent fuel rod storage pond.

19. The apparatus of claim 11, further comprising an electrical generator driven by the heat engine.

20. The apparatus of claim 19, wherein the liquid circulating pump obtains operating power from the electrical generator.

21. The apparatus of claim 19, wherein the electrical generator is disposed within the spent fuel rod storage pond.

22. The apparatus of claim 11, further comprising at least one electrically operated ancillary apparatus which is a member of the group including motor controls, instrumentation, alarms, annunciators, and valve operators wherein at least one of the electrically operated ancillary apparatuses is located exteriorly of the spent fuel rod storage pond.

23. The apparatus of claim 11, wherein the cooling system further comprises an adsorption cooling system.

24. The apparatus of claim 11, wherein the cooling system further comprises an evaporative cooling tower, and further wherein the thermal energy of spent fuel rods is used to generate air currents serving the evaporative cooling tower.

25. The apparatus of claim 11, wherein the at least one cooling system of said nuclear power plant is arranged to cool the spent fuel rod storage pond.

26. The apparatus of claim 11, wherein the at least one cooling system of said nuclear power plant is arranged to cool both the spent fuel rod storage pond and also the cooling system of the main reactor.

27. A nuclear electrical generating plant comprising:
a main reactor utilizing fuel rods to generate heat;
a spent fuel rod storage pond comprising a fluid and spent fuel rods which evolve waste heat;
at least one cooling system arranged to cool both the spent fuel rod storage pond and also the main reactor, the cooling system having at least one liquid circulating pump; and
an apparatus that harnesses the thermal energy of spent fuel rods of the nuclear power plant to power at least one cooling system of said nuclear power plant, comprising
a heat engine disposed to convert thermal energy from the waste heat to mechanical power, and
a heat conveyance system that conveys thermal energy of the spent fuel rods to the heat engine.
